(19) United States
(12) Patent Application Publication
(10) Pub. No.: US 2024/0112854 A1
(43) Pub. Date: Apr. 4, 2024

(54) METHOD FOR RECYCLING RARE EARTH ELEMENT-CONTAINING POWDER, AND METHOD FOR PRODUCING RARE EARTH SINTERED MAGNET

(71) Applicant: PROTERIAL, LTD., Tokyo (JP)

(72) Inventors: Takahiro YOMOGITA, Tokyo (JP); Futoshi KUNIYOSHI, Tokyo (JP)

(73) Assignee: PROTERIAL, LTD., Tokyo (JP)

(21) Appl. No.: 18/476,691

(22) Filed: Sep. 28, 2023

(30) Foreign Application Priority Data
Sep. 29, 2022 (JP) 2022-155891
Feb. 24, 2023 (JP) 2023-027602

(51) Int. Cl. H01F 41/00; B22F 1/05; B22F 3/16; B22F 9/04; C22C 38/00; C22C 38/06; C22C 38/10; C22C 38/14; C22C 38/16; H01F 1/053

(52) U.S. Cl. CPC H01F 41/00; B22F 1/05; B22F 3/16; B22F 9/04; C22C 38/002; C22C 38/005; C22C 38/06; C22C 38/10; C22C 38/14; C22C 38/16; H01F 1/0536; B22F 2009/044; B22F 2201/20; B22F 2202/05; B22F 2301/355; B22F 2304/10; B22F 2998/10; B22F 2999/00

(57) ABSTRACT

A method for recycling a rare earth element-containing powder, including:
disintegrating a molded body for a rare earth sintered magnet including a rare earth element-containing powder in oil such that a 149 mesh-pass, 500 mesh-on powder is included; and
separating and collecting a 149 mesh-pass powder obtained after the disintegrating to obtain a recycles powder.

### BACKGROUND OF THE INVENTION

### Field of the Invention

The present disclosure relates to a method for recycling a rare earth element-containing powder and a method for producing a rare earth sintered magnet.

### Description of the Related Art

Rare earth sintered magnets such as an R-T-B-based sintered magnet (R is a rare earth element, T is Fe or Fe and Co, and B is boron) and a samarium-cobalt-based sintered magnet can be produced by the following: pulverizing a casting alloy feedstock having a desired composition prepared by a strip casting method or the like from a melted raw material such as metal to obtain an alloy powder having a predetermined grain size (and/or grain size frequency distribution); molding the alloy powder by a wet-molding method or the like to obtain a molded body (or green compact); and sintering and heat-treating the molded body.

The molded body may come into contact with something to lose a part thereof and take a shape different from a desired shape during handling such as carrying it, or may crack due to some troubles during molding, so that a defective molded product may be generated.

Furthermore, for example, in order not to increase the number of types of a mold for use in press molding, in some cases, a molded body having a desired size is obtained by temporarily obtaining a molded body having a general size by press molding, and subsequently subjecting the molded body to cutting processing. In this case, a part of the molded body having a general size remains as a molded body having an incomplete size (hereinafter be referred to as a “molded body scrap”).

Regarding the supply of rare earth elements for use in rare earth sintered magnets, concerns about both the price and the production quantity have increased more than before, and a demand for effective reuse of such defective molded products and molded body scraps has increased more than before.

WO 2011/125578 A 1 discloses a method for recycling (a slurry including) a rare earth element-containing powder by disintegrating a molded body for a rare earth sintered magnet, the molded body including a rare earth element-containing powder, in oil over time by applying a moderate force such that the particle diameter of the powder does not change. Patent Document 1 discloses that when the method disclosed therein is used, even if a recycled slurry is used, magnetic properties are not changed as compared with a rare earth sintered magnet produced as usual.

### SUMMARY OF THE INVENTION

In the known technique as disclosed in Patent Document 1, a molded body is disintegrated over a long time so that powder aggregates are not present in a slurry (so that, for example, the slurry can pass through a sieve of 500 meshes/inch (hereinafter also referred to as “opening: 25 μm” or “ 500 mesh”) (this property is hereinafter also referred to as “500 mesh-pass”)). However, when a long time is spent for the disintegrating step in the production of a rare earth sintered magnet, such problems as degradation of a defective molded product and a molded body scrap during storage occur in addition to deterioration of productivity.

The present disclosure has been made in view of these circumferences, and it is an object of the present disclosure to provide a method for recycling a rare earth element-containing powder, the method being capable of reducing a time required for disintegrating, and a method for producing a rare earth sintered magnet.

A first aspect of the present invention provides a method for recycling a rare earth element-containing powder, including:
disintegrating a molded body for a rare earth sintered magnet including a rare earth element-containing powder in oil such that a 149 mesh-pass, 500 mesh-on powder is included; and
separating and collecting a 149 mesh-pass powder out of a powder obtained after the disintegrating to obtain a recycled powder.

A second aspect of the present invention provides a method for producing a rare earth sintered magnet, including:
obtaining a slurry including the recycled powder recycled by the method according to claim 1 and oil;
wet-molding the slurry in a magnetic field to obtain a molded body; and
sintering the molded body obtained after the wet-molding.

### DETAILED DESCRIPTION OF EMBODIMENTS

The present inventors have studied from various angles in order to realize a method for recycling a rare earth element-containing powder, the method being capable of reducing a time required for disintegrating.

In the known technique as disclosed in WO 2011/125578 A1, in order to ensure the magnetic properties of a sintered magnet, a molded body is disintegrated over a long time so that no aggregates are present in a recycled powder (for example, the recycled powder is 500 mesh (opening: 25 μm)-pass). However, the present inventors have found that even when aggregates are present to some extent in a powder obtained after the disintegrating (that is, even when there is a powder that is not 500 mesh-pass and remains on a 500 mesh sieve (hereinafter, this property is also referred to as “500 mesh-on”), if the size of the aggregates is within a predetermined range (that is, 149 mesh (opening: 100 μm)-pass), sufficient magnetic properties can be ensured in the sintered magnet using the disintegrated powder (for example, it enables to ensure a residual magnetic flux density which is equivalent as compared with a sintered magnet using an unrecycled powder (which may be, for example, a 500 mesh-pass) prepared as usual). That is, the present inventors have found that the time required for disintegrating can be shortened as compared with the known technique as a result of disintegrating to include a 149 mesh-pass, 500 mesh-on powder. The present inventors have also found that sufficient magnetic properties can be ensured in the sintered magnet as a result of separating and collecting a 149 mesh-pass powder out of a powder obtained after the disintegrating.

Hereinafter, details of each requirement defined by embodiments of the present invention will be described.

In this specification, the expression “disintegrate a molded body” means that an external force is applied to the molded body to obtain a powder, and the external force applied to the molded body is sufficient to break the molded body and obtain a powder, and has an appropriate strength that is not so great as to crush or wear the resulting powder. Although the resulting powder may be aggregated by a weak force such as an intermolecular force, “disintegrating” does not require to loosen the aggregation. In addition, the molded body according to the embodiments of the present invention includes, in addition to a molded body obtained by molding a rare earth element-containing powder, a molded body scrap generated when a molded body is subjected to cutting processing, and a molded body cut into a desired size after cutting processing.

### <1. Method for Recycling Rare Earth Element-Containing Powder>

A method for recycling a rare earth element-containing powder according to the embodiments of the present invention includes (1a) disintegrating a molded body for a rare earth sintered magnet including a rare earth element-containing powder in oil such that a 149 mesh-pass, 500 mesh-on powder is included; and (1b) separating and collecting a 149 mesh-pass powder out of a powder obtained after the disintegrating to obtain a recycled powder. This method enables that the time required for disintegrating is shortened, and that sufficient magnetic properties are ensured in a sintered magnet prepared using the recycled powder.

In the following, the respective steps are described in detail.

### <(1a) Disintegrating Molded Body for Rare Earth Sintered Magnet>

In the embodiments of the present invention, a molded body for a rare earth sintered magnet to be disintegrated includes a rare earth element-containing powder. The rare earth element-containing powder may be any powder including a rare earth element, and is preferably an alloy powder to be used for an R-T-B-based sintered magnet.

R in the alloy powder for an R-T-B-based sintered magnet is at least one selected from the group consisting of neodymium (Nd), praseodymium (Pr), dysprosium (Dy). and terbium (Tb), and preferably contains at least one of Nd or Pr. More preferably, R is one of the combinations of rare earth elements selected from the group consisting of Nd-Dy, Nd-Tb, Nd-Pr-Dy, and Nd-Pr-Tb. The alloy powder for an R-T-B-based sintered magnet containing Dy and/or Tb as R has an effect of improving the coercivity.

The alloy powder for an R-T-B-based sintered magnet may contain, as R, a small amount of other rare earth elements, such as Ce and La, in addition to the above elements. Mischmetal and/or didymium (alloy mainly containing Nd and Pr) may be used. R may not be a pure element, and may contain inevitable impurities as long as it is available for industrial use.

The R content in the alloy powder for an R-T-B-based sintered magnet may be 27% by mass or more and 33% by mass or less. When the R content is preferably 28% by mass or more and 31% by mass or less, higher magnetic properties can be ensured

T in the alloy powder for an R-T-B-based sintered magnet is Fe or Fe and Co. T contains Fe, and for example, 50% by mass or less of Fe may be replaced by cobalt (Co). Co can be effective for improving temperature characteristics and improving corrosion resistance. The Co content in the alloy powder for an R-T-B-based sintered magnet may be 10% by mass or less.

With respect to the T content in the R-T-B-based sintered magnet alloy powder, the balance of the R-T-B-based sintered magnet alloy powder is preferably T and inevitable impurities (for example, oxygen, nitrogen, carbon, and so on),

The B content in the alloy powder for an R-T-B-based sintered magnet is not particularly limited, and may be, for example, within a range of the B content of a publicly-known R-T-B-based sintered magnet. For example, the B content is preferably 0.9 to 1.2% by mass. When the B content is 0.9% by mass or more, a higher residual magnetic flux density can be ensured, and when the B content is 1.2% by mass or less, a higher coercivity can be ensured. A part of B may be replaced by C (carbon). The replacement by C has an effect of improving the corrosion resistance of the magnet. When B and C are added, the contents thereof are preferably adjusted to be within the above preferable range of the B concentration with conversion of the number of replaced C (carbon) atoms into the number of B atoms.

In addition to the above elements, an element M may be added for improving the coercivity. The element M is at least one element selected from the group consisting of Al, Si, Ti, V, Cr, Ni, Cu, Zn, Ga, Zr, Nb, Mo, In, Sn, Hf, Ta, and W. The addition amount of the element M is preferably 5.0% by mass or less in total. When the addition amount is 5.0% by mass or less, a higher residual magnetic flux density can be ensured.

The rare earth element-containing powder can be obtained, for example, by pulverizing, with an air-stream pulverizer (a jet mill) or the like, a casting alloy feedstock prepared by a strip casting method or the like. In order to obtain a sintered magnet having a higher residual magnetic flux density and a higher coercivity, the particle diameter D₅₀ of the rare earth element-containing powder is preferably 1.0 μm or more and 10.0 μm or less, and more preferably 2.0 μm or more and 5.0 μm or less. Herein, the particle diameter D₅₀ is a particle diameter at which an integration of grain size frequency distribution (on volume basis) from a small diameter side is 50% in a grain size frequency distribution obtained by a laser diffraction method using a gas flow dispersion method. The particle diameter D₅₀ can be measured, for example, using a grain size frequency distribution analyzer “HELOS & RODOS” manufactured by Sympatec GmbH under the conditions specified by a dispersion pressure of 4 bar, a measurement range of R2, and a measurement mode of HRLD.

In the embodiments of the present invention, the molded body for a rare earth sintered magnet is obtained by molding (for example, press molding) the rare earth element-containing powder by a publicly-known method. The molded body for a rare earth sintered magnet may be, for example, the defective molded product and the molded body scrap described above, but is not limited thereto, and may be, for example, various molded bodies such as a superfluous good molded body.

The molded body for a rare earth sintered magnet is preferably obtained by press molding the rare earth element-containing powder in a magnetic field (for example, 1 tesla (T) or more). As a result, the degree of three-directional orientation (hereinafter also simply referred to as “degree of orientation”) and the residual magnetic flux density of a sintered magnet described later can be improved.

Examples of the molding method include dry-molding in which a powder is molded as it is and wet-molding in which a powder is mixed with a dispersion medium to form a slurry and then molded. The wet-molding is preferable. In the wet-molding, the surface of the powder for constituting a molded body is covered with the dispersion medium, and contact with oxygen and water vapor in the air can be inhibited. As a result, oxidation of the powder by the air before and after molding or during molding can be inhibited. In this specification, the term “slurry” means a fluid that is a mixture of solid particles and a liquid, in which the solid particles are suspended in the liquid.

Hereinafter, a method of obtaining a molded body for a rare earth sintered magnet by wet press molding in a magnetic field will be described in detail.

In the case of performing wet press molding in a magnetic field, first, a slurry in which a dispersion medium is mixed with the rare earth element-containing powder is prepared. Examples of a preferable dispersion medium include one or more oils selected from the group consisting of mineral oils, synthetic oils, and vegetable oils. The oil preferably has a kinematic viscosity of 10 cSt or less at normal temperature. By using such an oil, local bonding between powders can be inhibited, and the degree of orientation of a resulting molded body can be improved. The fractional distillation point of the oil is preferably 400° C. or lower. This enables that deoiling after molding is facilitated to reduce the amount of residual carbon in a sintered magnet, and magnetic properties can be improved.

The concentration of the rare earth element-containing powder in the slurry is not particularly limited, bot is preferably 70% by mass or more. Thanks to this, for example, at a flow rate of 20 to 600 cm³/sec, the powder can be efficiently fed into a cavity, and the magnetic properties of a resulting sintered magnet can be improved. The upper limit of the concentration of the rare earth element-containing powder in the slurry is preferably 95% by mass or less from the viewpoint of fluidity of the slurry. The method for mixing the rare earth element-containing powder and the dispersion medium is not particularly limited. For example, the rare earth element-containing powder and the dispersion medium may be separately prepared, weighed to predetermined amounts, and then mixed. When the rare earth element-containing powder is obtained by dry pulverization with a jet mill or the like, a container containing a dispersion medium may be disposed at a powder discharge port of a pulverizer such as a jet mill, and the pulverized rare earth element-containing powder may be directly collected into the dispersion medium in the container to obtain a slurry. In this case, it is preferable to fill the inside of the container as well with an atmosphere composed of nitrogen gas and/or argon gas, and then directly collect the resulting rare earth element-containing powder in the dispersion medium without allowing the powder to come into contact with the air, to form a slurry. Furthermore, it is also possible to obtain a slurry by wet-pulverizing a raw material in a dispersion medium using a vibration mill, a ball mill, an attritor, or the like.

The slurry prepared as described above is fed to a cavity in a mold of a wet press molding apparatus and press molded in a magnetic field. The molded body thus formed may have a density of, for example, 4 g/cm³ or more and 5 g/cm³ or less. As a method of subjecting the molded body after molding to cutting processing, for example, publicly-known methods such as those described in JP H8-181028 A, JP 2003-303728 A, and JP 2021-155809 A may be employed. The molded body and molded body scraps after cutting are also encompassed in the molded body according to the embodiments of the present invention.

The molded body obtained as described above is disintegrated in oil. The term “in oil” refers to a state in which the molded body is completely immersed in oil or a state in which the surface of the molded body is covered with a film of the oil sufficient to prevent contact with oxygen in the air. As the oil, for example, one or more oils selected from the group consisting of mineral oils, synthetic oils, and vegetable oils can be used, and for example, an oil the same as or different from the oil being the dispersion medium of the slurry described above may be used. The disintegrating method is not particularly limited as long as the molded body can be disintegrated to include a 149 mesh-pass, 500 mesh-on powder. For example, the molded body may be disintegrated by simply pressing the molded body to break with a stainless steel member or the like, or may be disintegrated using a device as described in WO 2011/125578 A or WO 2013/047429 A. The powder obtained after the disintegrating preferably includes a 149 mesh-pass powder at a proportion as large as possible, and for example, the proportion is preferably 10% by mass or more, more preferably 25% by mass or more, still more preferably 50% by mass or more, further preferably 75% by mass or more, still further preferably 90% by mass or more, and particularly preferably 100% by mass. These can make the yield of the recycled powder to be further improved. In addition, the powder obtained after the disintegrating preferably includes a 500 mesh-on powder at a proportion as large as possible, and for example, the proportion is preferably 10% by mass or more, more preferably 25% by mass or more, still more preferably 50% by mass or more, further preferably 75% by mass or more, still further preferably 90% by mass or more, and particularly preferably 100% by mass. This can make the time required for the disintegrating to be further shortened as compared with the known technique in which all powder is made $00 mesh-pass in a disintegrating step. More preferably, the powder after obtained the disintegrating is composed of a 149 mesh-pass, 500 mesh-on powder.

<(1b) Separating and Collecting a 149 Mesh-Pass Powder Out of a Powder Obtained After the Disintegrating to Obtain a Recycled Powder>

Of the disintegrated powder obtained as described above, a 149 mesh-pass powder is separated and collected to obtain a recycled powder. This can be achieved, for example, by passing the powder obtained after the disintegrating through a 149 mesh sieve, and separate and collect the passed powder as a recycled powder.

The recycled powder separated and collected in the step (1b) may be stored in oil until use for molding.

The method for recycling a rare earth element-containing powder according to embodiments of the present invention may include other steps as long as the object can be achieved.

### <2. Method for Producing Rare Earth Sintered Magnet>

The method for producing a rare earth sintered magnet according to the embodiments of the present invention includes (2a) obtaining a slurry including the recycled powder recycled by the method described above and oil; (2b) wet-molding the slurry in a magnetic field to obtain a molded body; and (2c) a step of sintering the molded body obtained after the wet-molding.

In the following, the respective steps are described in detail.

### <(2a) Obtaining Slurry>

First, a slurry including the rare earth element-containing powder recycled by the above method and oil is prepared. Here, as the rare earth element-containing powder included in the slurry, only the recycled powder obtained by the method for recycling a rare earth element-containing powder according to the embodiments of the present invention may be included, or the recycled powder and an unrecycled rare earth element-containing powder having the same component composition as that of the recycled powder may be mixed and used. The oil included in the slurry may be the same oil as that included in the slurry described in “1. Method for recycling rare earth element-containing powder” above.

### <(2b) Wet-Molding Slurry to Obtain Molded Body>

The slurry is wet-molded in a magnetic field. The method of wet-molding in a magnetic field can also be performed in the same manner as the method described in “1. Method for recycling rare earth element-containing powder” above.

### <(2c) Sintering Molded Body Obtained After the Wet-Molding>

The molded body obtained is sintered. The sintering temperature is not particularly limited, and may be a temperature at which densification by sintering sufficiently take places, and may be, for example, 900° C. or more and 1100° C. or less.

In the rare earth sintered magnet (for example, R-T-B-based sintered magnet) obtained after the step (2c), the content of oxygen as an inevitable impurity is preferably 500 ppm or more and 8000 ppm or less, more preferably 500 ppm or more and 3200 ppm or less, and still more preferably 500 ppm or more and 2500 ppm or less. The content of nitrogen as an inevitable impurity is preferably 50 ppm or more and 1000 ppm or less. The content of carbon as an inevitable impurity is preferably 50 ppm or more and 2000 ppm or less.

The method for producing a rare earth sintered magnet according to the embodiments of the present invention may include other steps as long as the object can be achieved. For example, after sintering, it is preferable to perform heat treatment at 400° C. or more and 950° C. or less and at a temperature lower than the sintering temperature in a vacuum or an inert gas atmosphere. In this way, a high coercivity can be ensured.

### EXAMPLES

The embodiments of the present invention will be described in more detail by way of Examples. It is to be understood that the embodiments of the present invention are not limited to the following Examples, and various design variations made in accordance with the purports mentioned hereinbefore and hereinafter are also included in the scope of the embodiments of the present invention.

### Experimental Example 1

Raw materials of the respective elements were weighed to have a composition including Nd: 23.4%, Pr: 7.4%, B: 0.89%, Co: 0.8%, Al: 0.1%, Cu: 0.15%, Ga: 0.4%, Zr: 0.1% (all in % by mass), and the balance: Fe and inevitable impurities, and were processed by a strip casting method to obtain a casting alloy feedstock. The casting alloy feedstock was hydrogen-pulverized to obtain a coarsely pulverized powder. Zinc stearate as a lubricant was added to and mixed with the coarsely pulverized powder in an amount of 0.04 parts % by mass based on 100 parts % by mass of the coarsely pulverized powder. Then the mixture was dry. pulverized in a nitrogen flow using a jet mill to obtain a rare earth element-containing powder having a particle diameter D₅₀ of 4.8 μm. The D₅₀ was measured using a grain size frequency distribution analyzer “HELOS & RODOS” manufactured by Sympatec GmbH under the conditions specified by a dispersion pressure of 4 bar, a measurement range of R2, and a measurement mode of HRLD.

A part of the rare earth element-containing powder was collected as Unrecycled Powder 1. Whole Unrecycled Powder I was 500 mesh-pass.

Another part of the rare earth element-containing powder was immersed in mineral oil having a fractional distillation point of 250° C. and a kinematic viscosity of 2 cSt at room temperature in a nitrogen atmosphere to prepare a slurry. The concentration of the rare earth element-containing powder in the slurry was 75% by mass. The slurry obtained was molded (wet-molded) in a magnetic field of 1.6 T to prepare a molded body.

A stainless steel container containing oil was prepared in a box filled with a nitrogen atmosphere. While the molded body was immersed in the off, the molded body was disintegrated by being pressed from above to break in another stainless steel container, and a 280 mesh (opening: 53 μm)-pass powder was collected to obtain Recycled Powder 1. It can be considered that Recycled Powder 1 was a powder that passed barely through a 280 mesh sieve (opening: 53 μm), and most of Recycled Powder 1 was 500 mesh (opening: 25 μm)-on (for example, including 50% by mass or more of a 500 mesh-on powder). Further, since Recycled Powder 1 was 280 mesh (opening: 53 μm)-pass. Recycled Powder 1 can be said to be a 149 mesh-pass powder, that is, a powder that also passes through a 149 mesh sieve (opening: 100 μm), which is coarser than the 280 mesh sieve.

Recycled Powder 2 was obtained in the same manner as Recycled Powder 1 except that a powder of 149 mesh (opening: 100 μm)-pass and 280 mesh (opening: 53 μm)-on was separated and collected. Since Recycled Powder 2 is 280 mesh (opening: 53 μm)-on, Recycled Powder 2 can be said to be a 500 mesh-on powder, that is, a powder that also remains on a 500 mesh sieve (opening: 25 μm), which is finer than the 280 mesh sieve.

Recycled powder 3 was obtained in the same manner as Recycled Powder 1 except that a powder of 50 mesh (opening: 300 μm)-pass and 149 mesh (opening: 100 μm)-on was separated and collected.

Unrecycled Powder 1 and Recycled Powders 1 to 3 were each immersed in mineral oil having a fractional distillation point of 250° C. and a kinematic viscosity of 2 cSt at room temperature in a nitrogen atmosphere to prepare slurries. Each of the concentrations of the rare earth element-containing powders in the slurries was 75% by mass. Each of the slurries obtained was molded (wet-molded) in a magnetic field of 1.6 T to prepare molded bodies using the respective powders.

The molded bodies obtained were each sintered (the sintering temperature was set to a temperature at which densification due to sintering sufficiently took place) in vacuum for 4 hours and then rapidly cooled to obtain sintered bodies using the respective powders, The density of each of the sintered bodies was 7.5 Mg/m³ or more, Further, the sintered bodies using the respective powders were subjected to heat treatment of heating to 800° C. After the heat treatment, the entire surface of each of the sintered bodies using the respective powders was cut using a surface grinder to obtain rare earth sintered magnets Nos. 1 to 4 each having a cubic shape of 7.0 mm×7.0 mm×7.0 mm.

For the rare earth sintered magnets Nos, 1 to 4, a residual magnetic flux density Bᵣₓ (unit: Tesla (T)) in a magnetic field application direction (referred to as X direction) at the time of molding was measured with a B-H tracer. In addition, a residual magnetic flux density B_{ry} (unit: Tesla (T)) in a direction perpendicular to the X direction (hereinafter also referred to as “Y direction”) and a residual magnetic flux density Ba (unit: Tesla (T)) in a direction perpendicular to the X direction and the Y direction (hereinafter also referred to as “Z direction”) were measured with a B-H tracer. A degree of three-directional orientation OR was determined from the following formula (1).

OR=Bᵣₓ/((Bᵣₓ)²+(B_{ry})²+(B_{rz})²)^{1/2} (1)

The contents of oxygen and carbon in the rare earth sintered magnets Nos. 1 to 4 were measured using a gas analyzer by a gas fusion-infrared absorption method.

The results are summarized in Table 1. In Table 1, the rare earth sintered magnet No. 1 prepared using Unrecycled Powder 1 is for comparison, and thus “−” is entered in the blank of judgment of magnetic properties. In addition, in Table 1, in the blanks of judgment of magnetic properties of the rare earth sintered magnets Nos. 2 to 4 prepared using Recycled Powders 1 to 3, respectively, a magnet having Bᵣₓ equal to that of the rare earth sintered magnet No. 1 (less than 0.1 T even if the Box decreased) was evaluated as sufficient (Good), and a magnet having Bᵣₓ decreased by 0.1 T or more was evaluated as insufficient (Poor).

TABLE 1

| Rare earth element-containing | | | Rare earth sintered | | | | | | |
|---|---|---|---|---|---|---|---|---|---|
| powder used | | | magnet | | | | | | |
| | Mesh size | Mesh size | | Oxygen | Carbon | Magnetic properties | | | |
| | for | for | | content | content | Brx | | | |
| Powder No. | mesh-pass | mesh-on | No. | (ppm) | (ppm) | (T) | OR | Judgment | Remarks |
| Unrecycled | 500 mesh | — | 1 | 1510 | 940 | 1.43 | 0.988 | — | |
| Powder 1 | (opening: | | | | | | | | |
| | 25 μm) | | | | | | | | |
| Recycled | 280 mesh | — | 2 | 1790 | 920 | 1.43 | 0.988 | Good | Example |
| Powder 1 | (opening: | | | | | | | | |
| | 53 μm) | | | | | | | | |
| Recycled | 149 mesh | 280 mesh | 3 | 1680 | 940 | 1.43 | 0.988 | Good | Example |
| Powder 2 | (opening: | (opening: | | | | | | | |
| | 100 μm) | 53 μm) | | | | | | | |
| Recycled | 50 mesh | 149 mesh | 4 | 1550 | 960 | 1.42 | 0.984 | Poor | Comparative |
| Powder 3 | (opening: | (opening: | | | | | | | Example |
| | 300 μm) | 100 μm) | | | | | | | |

Table 1 shows the following.

Recycled Powders 1 and 2 were powders recycled by a method that satisfies all the requirements defined in the method for recycling a rare earth element-containing powder according to the embodiments of the present invention, and were disintegrated to include a 500 mesh-on powder, so that it was possible to shorten the time required for disintegrating as compared with the known technique in which a molded body is disintegrated over a long time so that all powder becomes 500 mesh-pass. According to the inventors, it has been confirmed that in about half the time taken for disintegrating to obtain a certain amount of Recycled Powder 1, the same amount of Recycled Powder 2 can be obtained. In view of the fact that the time required for disintegrating was reduced to approximately half when the mesh size for mesh-pass is changed from 280 mesh to 149 mesh, which is an approximately half mesh size (that is, approximately double in opening size), it can be considered that, as compared with the case of obtaining a certain amount of a powder made to be 500 mesh-pass, which is equivalent to the unrecycled raw material, the same amount of Recycled Powder I can be obtained in a time approximately half of the time required for the disintegrating in the above comparative case, and the same amount of Recycled Powder 2 can be obtained in a time approximately one fourth of the time required for the disintegrating in the above comparative case.

The rare earth sintered magnets Nos. 2 and 3 using Recycled Powders 1 and 2 were sintered magnets prepared by a method that satisfies all the requirements defined in the method for producing a rare earth sintered magnet according to the embodiments of the present invention. Each of the oxygen contents increased to about 300 ppm but was in an tolerable range as compared with the rare earth sintered magnet No. 1 using Unrecycled Powder 1, and each of the carbon contents hardly changed. Thus, they exhibited sufficient magnetic properties (that is, each the Bᵣₓ was equivalent to that of the rare earth sintered magnet No. 1 using Unrecycled Powder 1). In addition, since the oxygen content of the rare earth sintered magnet No. 2 using Recycled Powder 1 that took a long time for disintegrating was as large as 1790 ppm as compared with the oxygen content of 1680 ppm of the rare earth sintered magnet No. 3 using Recycled Powder 2, it can be considered that there was a correlation between the length of time required for disintegrating and the increase in the oxygen content. Therefore, it can be presumed that the oxygen content of a 500 mesh-pass recycled powder, which is expected to take longer time for disintegrating than that of Recycled Powder 1, is larger than that of the rare earth sintered magnet No. 2 using Recycled Powder 1.

On the other hand, Recycled Powder 3 was obtained by separating and collecting a 50 mesh (opening: 300 μm)-pass, 149 mesh (opening: 100 μm)-on powder out of a powder obtained after the disintegrating, and the time required for disintegrating to obtain a certain amount of a recycled powder was shorter in Recycled Powder 3 than in Recycled Powder 2. The rare earth sintered magnet No. 4 using Recycled Powder 3 had the same oxygen content as that of the rare earth sintered magnet No. 1 using Unrecycled Powder 1, but the magnetic properties of the rare earth sintered magnet No. 4 were insufficient. This can be considered because the degree of three-directional orientation OR of the rare earth sintered magnet No. 4 was lower than that of the rare earth sintered magnet No. 1. The reason why the degree of orientation of the rare earth sintered magnet No. 4 decreased can be considered as follows. That is, it can be considered that Recycled Powder 3 was a relatively large powder having a size of 149 mesh-on, and the large powder easily came into contact with other powders and received a frictional force, so that the easy magnetization direction of the large powder was hardly sufficiently oriented in the magnetic field application direction during molding.

### Experimental Example 2

Raw materials of the respective elements were weighed to have a composition including Nd: 23.8%, Pr: 6.7%, Dy: 0.0%, B: 0.96%, Co: 0.9%, Al: 0.1%, Cu: 0.1%, Ga: 0.1%, Zr: 0.05% (all in % by mass), and the balance: Fe and inevitable impurities, and were processed by a strip casting method to obtain a casting alloy feedstock. The casting alloy feedstock was hydrogen-pulverized to obtain a coarsely pulverized powder. Paraffin wax as a lubricant was added to and mixed with the coarsely pulverized powder in an amount of 0.04 parts % by mass based on 100 parts % by mass of the coarsely pulverized powder. Then the mixture was dry-pulverized in a nitrogen flow using a jet mill to obtain a rare earth element-containing powder having a particle diameter D₅₀ of 4.0 μm. The D₅₀ was measured using a grain size frequency distribution analyzer “HELOS & RODOS” manufactured by Sympatec Gmbh under the conditions specified by a dispersion pressure of 4 bar, a measurement range of R2, and a measurement mode of HRLD.

A part of the rare earth element-containing powder was collected as Unrecycled Powder 11. Whole Unrecycled 11 was 500 mesh-pass.

Another part of the rare earth element-containing powder was immersed in mineral oil having a fractional distillation point of 250° C. and a kinematic viscosity of 2 cSt at room temperature in a nitrogen atmosphere to prepare a slurry. The concentration of the rare earth element-containing powder in the slurry was 75% by mass. The slurry was molded (wet-molded) in a magnetic field of 1.6 T to prepare a molded body.

Recycled powder 11 was obtained in the same manner as in Experimental Example 1 except that a powder of 149 mesh (opening: 100 μm)-pass and 280 mesh (opening: 53 μm)-on was separated and collected. Since Recycled Powder 11 was 280 mesh (opening: 53 μm)-on, Recycled Powder 2 can be said to be a 500 mesh-on powder, that is, a powder that also remains on a 500 mesh sieve (opening: 25 μm), which is finer than the 280 mesh sieve.

Recycled powder 12 was obtained in the same manner as in Experimental Example 1 except that a powder of 50 mesh (opening: 300 μm)-pass and 149 mesh (opening: 100 μm)-on was separated and collected.

Unrecycled Powder 11 and Recycled Powders 11 to 12 were each immersed in mineral oil having a fractional distillation point of 250° C. and a kinematic viscosity of 2 cSt at room temperature in a nitrogen atmosphere to prepare slurries, Each of the concentrations of the rare earth element-containing powders in the slurries was 75% by mass. Each of the slurries obtained was molded (wet-molded) in a magnetic field of 1.6 T to prepare molded bodies using the respective powders.

The molded bodies obtained were each sintered (the sintering temperature was set to a temperature at which densification due to sintering sufficiently took place) in vacuum for 4 hours and then rapidly cooled to obtain sintered bodies using the respective powders. The density of each of the sintered bodies was 7.5 Mg/m³ or more. Further, the entire surface of each of the sintered bodies using the respective powders was cut using a surface grinder to obtain rare earth sintered magnets Nos. 11 to 13 each having a cubic shape of 7.0 mm×7.0 mm×7.0 mm.

For the rare earth sintered magnets Nos. 11 to 13, a residual magnetic flux density Bᵣₓ (unit: Tesla (T)) in a magnetic field application direction (referred to as X direction) at the time of molding was measured with a B-H tracer.

The degree of three-directional orientation OR and the contents of oxygen and carbon in the rare earth sintered magnets 11 to 13 were determined in the same manner as in Experimental Example 1.

The results are summarized in Table 2. In Table 2, the rare earth sintered magnet No. 11 prepared using Unrecycled Powder 11 is for comparison, and thus “−” is entered in the blank of judgment of magnetic properties. In addition, in Table 2, in the blanks of judgment of magnetic properties of the rare earth sintered magnets Nos. 12 to 13 prepared using Recycled Powders 11 to 12, respectively, a magnet having Bes equal to that of the rare earth sintered magnet No. 11 (less than 0.1 T even if the Bᵣₓ decreased) was evaluated as sufficient (Good), and a magnet having Bᵣₓ decreased by 0.1 T or more was evaluated as insufficient (Poor).

TABLE 2

| Rare earth element-containing | | | Rare earth sintered | | | | | | |
|---|---|---|---|---|---|---|---|---|---|
| powder used | | | magnet | | | | | | |
| | Mesh size | Mesh size | | Oxygen | Carbon | Magnetic properties | | | |
| | for | for | | content | content | Brx | | | |
| Powder No. | mesh-pass | mesh-on | No. | (ppm) | (ppm) | (T) | OR | Judgment | Remarks |
| Unrecycled | 500 mesh | — | 11 | 1059 | 887 | 1.43 | 0.982 | — | |
| Powder 11 | (opening: | | | | | | | | |
| | 25 μm) | | | | | | | | |
| Recycled | 149 mesh | 280 mesh | 12 | 1729 | 910 | 1.43 | 0.981 | Good | Example |
| Powder 11 | (opening: | (opening: | | | | | | | |
| | 100 μm) | 53 μm) | | | | | | | |
| Recycled | 50 mesh | 149 mesh | 13 | 1562 | 914 | 1.42 | 0.980 | Poor | Comparative |
| Powder 12 | (opening: | (opening: | | | | | | | Example |
| | 300 μm) | 100 μm) | | | | | | | |

Table 2 shows the following.

Recycled Powder 11 was a powder recycled by a method that satisfies all the requirements defined in the method for recycling a rare earth element-containing powder according to the embodiments of the present invention, and was disintegrated to include a 500 mesh-on powder, so that it was possible to shorten the time required for disintegrating as compared with the known technique in which a molded body is disintegrated over a long time so that all powder becomes 500 mesh-pass.

The rare earth sintered magnet No. 12 using Recycled Powder 11 was a sintered magnets prepared by a method that satisfies all the requirements defined in the method for producing a rare earth sintered magnet according to the embodiments of the present invention, and the oxygen content increased to about 700 ppm but was in a tolerable range as compared with the rare earth sintered magnet No. 11 using Unrecycled Powder 11, and the carbon content hardly changed. Thus, this exhibited sufficient magnetic properties (that is, the Bᵣₓ was equivalent to that of the rare earth sintered magnet No. 11 using Unrecycled Powder 11).

On the other hand, Recycled Powder 12 was obtained by separating and collecting a 50 mesh (opening: 300 μm)-pass, 149 mesh (opening: 100 μm)-on powder out of a powder obtained after the disintegrating, and the time required for disintegrating to obtain a certain amount of a recycled powder was shorter in Recycled Powder 12 than in Recycled Powder 11, but the magnetic properties of the rare earth sintered magnet No. 13 were insufficient. This can be considered because the degree of three-directional orientation OR of the rare earth sintered magnet No. 13 was lower than that of the rare earth sintered magnet No. 11.

### Experimental Example 3

Raw materials of the respective elements were weighed to have a composition including Nd: 23.8%, Pr: 6.7%, Dy: 0.0%, B: 0.96%, Co: 0.9%, Al: 0.1%, Co: 0.1%, Ga: 0.1%, Zr: 0.05% (all in % by mass), and the balance: Fe and inevitable impurities, and were processed by a strip casting method to obtain a casting alloy feedstock. The casting alloy feedstock was hydrogen-pulverized to obtain a coarsely pulverized powder. Paraffin wax as a lubricant was added to and mixed with the coarsely pulverized powder in an amount of 0.04 parts % by mass based on 100 parts % by mass of the coarsely pulverized powder, and then the mixture was dry-pulverized in a nitrogen flow using a jet mill to obtain a rare earth element-containing powder having a particle diameter D₅₀ of 3.2 μm. The D₅₀ was measured using a grain size frequency distribution analyzer “HELOS & RODOS” manufactured by Sympatec GmbH under the conditions specified by a dispersion pressure of 4 bar, a measurement range of R2, and a measurement mode of HRLD.

A part of the rare earth element-containing powder was collected as Unrecycled Powder 21. Whole Unrecycled 21 was 500 mesh-pass.

Another part of the rare earth element-containing powder was immersed in mineral oil having a fractional distillation point of 250° C. and a kinematic viscosity of 2 cSt at room temperature in a nitrogen atmosphere to prepare a slurry. The concentration of the rare earth element-containing powder in the slurry was 75% by mass. The slurry obtained was molded (wet-molded) in a magnetic field of 1.6 T to prepare a molded body.

Recycled powder 21 was obtained in the same manner as in Experiment Example 1 except that a powder of 149 mesh (opening: 100 μm)-pass and 280 mesh (opening: 53 μm)-on was separated and collected. Since Recycled Powder 21 was 280 mesh (opening: 53 μm)-on, Recycled Powder 2 can be said to be a 500 mesh-on powder, that is, a powder that also remains on a 500 mesh sieve (opening: 25 μm), which is finer than the 280 mesh sieve.

Recycled powder 22 was obtained in the same manner as in Experimental Example 1 except that a powder of 50 mesh (opening: 300 μm)-pass and 149 mesh (opening: 100 μm)-on was separated and collected.

Unrecycled Powder 21 and Recycled Powders 21 to 22 were each immersed in mineral oil having a fractional distillation point of 250° C. and a kinematic viscosity of 2 cSt at room temperature in a nitrogen atmosphere to prepare slurries. Each of the concentrations of the rare earth element-containing powders in the slurries was 75% by mass. Each of the slurries obtained was molded (wet-molded) in a magnetic field of 1.6 T to prepare molded bodies using the respective powders.

The molded bodies obtained were each sintered (the sintering temperature was set to a temperature at which densification due to sintering sufficiently took place) in vacuum for 4 hours and then rapidly cooled to obtain sintered bodies using the respective powders. The density of each of the sintered bodies was 7.5 Mg/m³ or more. Further. the entire surface of each of the sintered bodies using the respective powders was cut using a surface grinder to obtain rare earth sintered magnets Nos. 21 to 23 each having a cubic shape of 7.0 mm×7.0 mm×7.0 mm.

For the rare earth sintered magnets Nos. 21 to 23, a residual magnetic flux density Bᵣₓ (unit: Tesla (T)) in a magnetic field application direction (referred to as X direction) at the time of molding was measured with a B-H tracer.

The degree of three-directional orientation OR and the contents of oxygen and carbon in the rare earth sintered magnets 21 to 23 were determined in the same manner as in Experimental Example 1.

The results are summarized in Table 3. In Table 3, the rare earth sintered magnet No. 21 prepared using Unrecycled Powder 21 is for comparison, and thus “−” is entered in the blank of judgment of magnetic properties. In addition, in Table 3, in the blanks of judgment of magnetic properties of the rare earth sintered magnets Nos. 22 to 23 prepared. using Recycled Powders 21 to 22, respectively, a magnet having Bᵣₓ equal to that of the rare earth sintered magnet No. 1 (less than 0.1 T even if the Bᵣₓ decreased) was evaluated as sufficient (Good), and a magnet having Bᵣₓ decreased by 0.1 T or more was evaluated as insufficient (Poor).

TABLE 3

| Rare earth element-containing | | | Rare earth sintered | | | | | | |
|---|---|---|---|---|---|---|---|---|---|
| powder used | | | magnet | | | | | | |
| | Mesh size | Mesh size | | Oxygen | Carbon | Magnetic properties | | | |
| | for | for | | content | content | Brx | | | |
| Powder No. | mesh-pass | mesh-on | No. | (ppm) | (ppm) | (T) | OR | Judgment | Remarks |
| Unrecycled | 500 mesh | — | 21 | 1112 | 994 | 1.43 | 0.982 | — | |
| Powder 21 | (opening: | | | | | | | | |
| | 25 μm) | | | | | | | | |
| Recycled | 149 mesh | 280 mesh | 22 | 1855 | 1064 | 1.43 | 0.982 | Good | Example |
| Powder 21 | (opening: | (opening: | | | | | | | |
| | 100 μm) | 53 μm) | | | | | | | |
| Recycled | 50 mesh | 149 mesh | 23 | 1727 | 1030 | 1.42 | 0.979 | Poor | Comparative |
| Powder 22 | (opening: | (opening: | | | | | | | Example |
| | 300 μm) | 100 μm) | | | | | | | |

Table 3 shows the following.

Recycled Powder 21 was a powder recycled by a method that satisfies all the requirements defined in the method for recycling a rare earth element-containing powder according to the embodiments of the present invention, and was disintegrated to include a 500 mesh-on powder, so that it was possible to shorten the time required for disintegrating as compared with the known technique in which a molded body is disintegrated over a long time so that all powder becomes 500 mesh-pass.

The rare earth sintered magnet No. 22 using Recycled Powder 21 was a sintered magnets prepared by a method that satisfies all the requirements defined in the method for producing a rare earth sintered magnet according to the embodiments of the present invention, and the oxygen content increased to about 700 ppm but was in a tolerable range as compared with the rare earth sintered magnet No. 21 using Unrecycled Powder 21, and the carbon content hardly changed. Thus, this exhibited sufficient magnetic properties (that is, the Box was equivalent to that of the rare earth sintered magnet No. 21 using Unrecycled Powder 21).

On the other hand, Recycled Powder 22 was obtained by separating and collecting a 50 mesh (opening: 300 μm)-pass, 149 mesh (opening: 100 μm) on powder out of a powder obtained after the disintegrating, and the time required for disintegrating to obtain a certain amount of a recycled powder was shorter in Recycled Powder 22 than in Recycled Powder 21, but the magnetic properties of the rare earth sintered magnet No. 23 were insufficient. This can be considered because the degree of three-directional orientation OR of the rare earth sintered magnet No. 23 was lower than that of the rare earth sintered magnet No. 21.

### Experiment Example 4

Raw materials of the respective elements were weighed to have a composition including Nd: 17.6%, Pr: 4.9%, Dy: 8.0%, B: 0.96%, Co: 0.9%, Al: 0.1%, Cu: 0.1%, Ga: 0.1%, Zr: 0.05% (all in % by mass), and the balance: Fe and inevitable impurities, and were processed by a strip casting method to obtain a casting alloy feedstock. The casting alloy feedstock was hydrogen-pulverized to obtain a coarsely pulverized powder. Paraffin wax as a lubricant was added to and mixed with the coarsely pulverized powder in an amount of 0.04 parts % by mass based on 100 parts % by mass of the coarsely pulverized powder. Then, the mixture was dry-pulverized in a nitrogen flow using a jet mill to obtain a rare earth element-containing powder having a particle diameter D₅₀ of 3.2 μm. The D₅₀ was measured using a grain size frequency distribution analyzer “HELOS & RODOS” manufactured by Sympatec GmbH under the conditions specified by a dispersion pressure of 4 bar, a measurement range of R2, and a measurement mode of HRLD.

A part of the rare earth element-containing powder was collected as Unrecycled Powder 31. Whole Unrecycled 31 was 500 mesh-pass,

Another part of the rare earth element-containing powder was immersed in mineral oil having a fractional distillation point of 250° C. and a kinematic viscosity of 2 cSt at room temperature in a nitrogen atmosphere to prepare a slurry. The concentration of the rare earth element-containing powder in the slurry was 75% by mass. The slurry obtained was molded (wet-molded) in a magnetic field of 1.6 T to prepare a molded body.

Recycled powder 31 was obtained in the same manner as in Experiment Example 1 except that a powder of 149 mesh (opening: 100 μm)-pass and 280 mesh (opening: 53 μm)-on was separated and collected. Since Recycled Powder 31 was 280 mesh (opening: 53 μm)-on, Recycled Powder 2 can be said to be a 500 mesh-on powder, that is, a powder that also remains on a 500 mesh sieve (opening: 25 μm), which is finer than the 280 mesh sieve.

Recycled powder 32 was obtained in the same manner as in Experimental Example 1 except that a powder of 50 mesh (opening: 300 μm)-pass and 149 mesh (opening: 100 μm)-on was separated and collected.

Unrecycled Powder 31 and Recycled Powders 31 to 32 were each immersed in mineral oil having a fractional distillation point of 250° C. and a kinematic viscosity of 2 cSt at room temperature in a nitrogen atmosphere to prepare slurries. Each of the concentrations of the rare earth element-containing powders in the slurries. Each of the slurries obtained was molded (wet-molded) in a magnetic field of 1.6 T to prepare molded bodies using the respective powders.

The molded bodies were each sintered (the sintering temperature was set to a temperature at which densification due to sintering sufficiently took place) in vacuum for 4 hours and then rapidly cooled to obtain sintered bodies using the respective powders. The density of each of the sintered bodies was 7.5 Mg/m³ or more. Further, the entire surface of each of the sintered bodies using the respective powders was cut using a surface grinder to obtain rare earth sintered magnets Nos. 31 to 33 each having a cubic shape of 7.0 mm×7.0 mm×7.0 mm.

For the rare earth sintered magnets Nos. 31 to 33, a residual magnetic flux density Bᵣₓ (unit: Tesla (T)) in a magnetic field application direction (referred to as X direction) at the time of molding was measured with a B-H tracer.

The degree of three-directional orientation OR and the contents of oxygen and carbon in the rare earth sintered magnets 31 to 33 were determined in the same manner as in Experimental Example 1.

The results are summarized in Table 4. In Table 4, the rare earth sintered magnet No. 31 prepared using Unrecycled Powder 31 is for comparison, and thus “−” is entered in the blank of judgment of magnetic properties. In addition, in Table 4, in the blanks of judgment of magnetic properties of the rare earth sintered magnets Nos. 32 to 33 prepared using Recycled Powders 31 to 32, respectively, a magnet having Bᵣₓ equal to that of the rare earth sintered magnet No. 1 (less than 0.1 T even if the Box decreased) was evaluated as sufficient (Good), and a magnet having Bix decreased by 0.1 T or more was evaluated as insufficient (Poor).

TABLE 4

| Rare earth element-containing | | | Rare earth sintered | | | | | | |
|---|---|---|---|---|---|---|---|---|---|
| powder used | | | magnet | | | | | | |
| | Mesh size | Mesh size | | Oxygen | Carbon | Magnetic properties | | | |
| | for | for | | content | content | Brx | | | |
| Powder No. | mesh-pass | mesh-on | No. | (ppm) | (ppm) | (T) | OR | Judgment | Remarks |
| Unrecycled | 500 mesh | — | 31 | 934 | 1031 | 1.22 | 0.978 | — | |
| Powder 31 | (opening: | | | | | | | | |
| | 25 μm) | | | | | | | | |
| Recycled | 149 mesh | 280 mesh | 32 | 1731 | 1054 | 1.22 | 0.978 | Good | Example |
| Powder 31 | (opening: | (opening: | | | | | | | |
| | 100 μm) | 53 μm) | | | | | | | |
| Recycled | 50 mesh | 149 mesh | 33 | 1625 | 1056 | 1.21 | 0.974 | Poor | Comparative |
| Powder 32 | (opening: | (opening: | | | | | | | Example |
| | 300 μm) | 100 μm) | | | | | | | |

Table 4 shows the following.

Recycled Powder 31 was a powder recycled by a method that satisfies all the requirements defined in the method for recycling a rare earth element-containing powder according to the embodiments of the present invention, and was disintegrated to include a 500 mesh-on powder, so that it was possible to shorten the time required for disintegrating as compared with the known technique in which a molded body is disintegrated over a long time so that all powder becomes 500 mesh-pass.

The rare earth sintered magnet No. 32 using Recycled Powder 31 was a sintered magnets prepared by a method that satisfies all the requirements defined in the method for producing a rare earth sintered magnet according to the embodiments of the present invention, and the oxygen content increased to about 800 ppm but was in a tolerable range as compared with the rare earth sintered magnet No. 31 using Unrecycled Powder 31, and the carbon content hardly changed. Thus, this exhibited sufficient magnetic properties (that is, the Bᵣₓ was equivalent to that of the rare earth sintered magnet No. 31 using Unrecycled Powder 31).

On the other hand, Recycled Powder 32 was obtained by separating and collecting 50 mesh (opening: 300 μm)-pass, 149 mesh (opening: 100 μm)-on powder out of a powder obtained after the disintegrating, and the time required for disintegrating to obtain a certain amount of a recycled powder was shorter in Recycled Powder 32 than in Recycled Powder 31, but the magnetic properties of the rare earth sintered magnet No. 33 were insufficient. This can be considered because the degree of three-directional orientation OR of the rare earth sintered magnet No. 33 was lower than that of the rare earth sintered magnet No. 31.

This application claims priority based on Japanese Applications No. 2022-155891 filed on Sep. 29, 2022 and No. 2023-027602 filed on Feb. 24, 2023, the disclosures of which are incorporated by reference herein.

What is claimed is:

1. A method for recycling a rare earth element-containing powder, comprising:
disintegrating a molded body for a rare earth sintered magnet comprising a rare earth element-containing powder in oil such that a 149 mesh-pass, 500 mesh-on powder is included; and
separating and collecting a 149 mesh-pass powder out of a powder obtained after the disintegrating to obtain a recycled powder.

2. The method according to claim 1, wherein the powder obtained after the disintegrating comprises a 500 mesh-on powder at a proportion 10% by mass.

3. The method according to claim 2, wherein the rare earth element-containing powder comprises the 500 mesh-on powder at a proportion 50% by mass.

4. The method according to claim 1, wherein the rare earth element-containing powder is an alloy powder comprising:
R: at least one selected from the group consisting of Nd, Pr. Dy, Tb, Ce and La;
T: Fe, or Fe and Co; and
B.

5. The method according to claim 4, wherein the alloy powder comprises:
the R: 27% by mass or more and 33% by mass or less; and
the B: 0.9% by mass or more and 1.2% by mass or less; with the balance consisting of the T and inevitable impurities.

6. The method according to claim 4, wherein the R is at least one selected from the group consisting of Nd, Pr, Dy and Tb.

7. The method according to claim 4, wherein the R. comprises at least one selected from the group consisting of Nd and Pr.

8. The method according to claim 4, wherein the Co content in the T is 50% by mass or less.

9. The method according to claim 4, wherein as a part of the B is replaced with C.

10. The method according to claim S, wherein the alloy powder further comprises more than 0% by mass and 5.0% by mass or less of M. which is at least one element selected from the group consisting of Al, Si, Ti, V, Cr, Ni, Cu, Zn, Ga, Zr, Nb, Mo, In, Sn, Hf, Ta, and W.

11. The method according to claim 1, wherein a particle diameter D₅₀ of the rare earth element-containing powder is 1.0 μm or more and 10.0 μm or less.

12. The method according to claim 11, wherein the particle diameter D₅₀ is 2.0 μm or more and 5.0 μm or less.

13. A method for producing a rare earth sintered magnet, comprising:
obtaining a slurry comprising the recycled powder recycled by the method according to claim 1 and oil;
wet-molding the slurry in a magnetic field to obtain a molded body; and
sintering the molded body obtained after the wet-molding.

14. The method according to claim 13, wherein a content of oxygen in the rare earth sintered magnet 500 ppm or more and 8,000 ppm or less.

15. The method according to claim 14, wherein the content of oxygen in the rare earth sintered magnet 500 ppm or more and 2,500 ppm or less.

16. The method according to claim 13, wherein a content of nitrogen in the rare earth sintered magnet 50 ppm or more and 2,000 ppm or less.

17. The method according to claim 13, wherein the oil is at least one selected from the group consisting of mineral oil, synthetic oil and vegetable oil.

18. The method according to claim 13, wherein the oil has a kinematic viscosity of 10 cSt or less at normal temperature.

19. The method according to claim 13, wherein a fractional distillation point of the oil is 400° C. or lower.

20. The method according to claim 13, wherein a concentration of a rare earth element-containing powder in the slurry is 70% by mass or more and 95% by mass or less.
